(19) United States
(12) Patent Application Publication
(10) Pub. No.: US 2025/0180524 A1
(43) Pub. Date: Jun. 5, 2025

(54) ROTATABLE SAMPLE NEEDLE FOR ANALYZER

(71) Applicant: Agilent Technologies, Inc., Santa Clara, CA (US)

(72) Inventors: Blasius Nocon, Rheinstetten (DE); Christoph Geiger, Birkenfeld (DE)

(21) Appl. No.: 18/836,683

(22) PCT Filed: Feb. 15, 2023
(86) PCT No.: PCT/IB2023/051357

§ 371 Date: Aug. 7, 2024

(30) Foreign Application Priority Data
Feb. 16, 2022 (DE) 10 2022 103 659.6

(51) Int. Cl. G01N 30/18; G01N 30/20; G01N 30/22

(52) U.S. Cl. CPC G01N 30/18; G01N 30/20; G01N 30/22; G01N 2030/202; G01N 2030/207

(57) ABSTRACT

A sample handling device for handling a fluid sample in an analyzer for analyzing the fluid sample includes a sample needle having a lumen (197) through which the fluid sample can be passed, and a movement apparatus for moving the sample needle. The sample needle is rotatably mounted with respect to the movement apparatus.

### CROSS-REFERENCE TO RELATED APPLICATIONS

This application is the national stage under 35 U.S.C. 371 of International Application No. PCT/IB2023/051357, filed Feb. 15, 2023; which claims priority to German Application No. DE 10 2022 103 659.6, filed Feb. 16, 2022; the entire contents of each of which are incorporated by reference herein.

### TECHNICAL FIELD

The present disclosure relates to a needle arrangement for a sample handling device of an analyzer for analyzing a fluidic sample, a sample handling device, an analyzer, and a method for operating an analyzer for analyzing a fluidic sample.

### BACKGROUND

In an HPLC, a liquid (mobile phase) is typically moved through a so-called stationary phase (for example in a chromatographic column) at a very precisely controlled flow rate (for example in the range of microliters to milliliters per minute) and at a high pressure (typically 20 to 1000 bar and beyond, currently up to 2000 bar), at which the compressibility of the liquid can be noticeable, in order to separate individual fractions of a sample liquid introduced into the mobile phase. After passing through the stationary phase, the separated fractions of the fluidic sample are detected in a detector. Such an HPLC system is known, for example, from EP 0,309,596 B1 of the same applicant, Agilent Technologies, Inc.

Before the separation process, the fluidic sample can be sucked into a sample loop by a mechanically drivable sample needle and subsequently injected from the sample loop into a separation path. The fluidic sample, which is initially at atmospheric pressure, can be injected by an injector to a high pressure in the separation path between a fluid drive and a sample separation device. The fluidic sample can be injected into the separation path by switching a fluid valve.

However, the correct operation of moving parts in a sample separation device in combination with a reliable liquid supply through a capillary can be difficult.

US 2010/0206044 A1 discloses a fluidic device comprising a capillary for guiding a fluid and a moving apparatus for rotating a needle. The moving apparatus can support at least part of the capillary. Part of the capillary is wound up in order to at least partially compensate for the mechanical load on the capillary resulting from the rotation of the moving apparatus.

### SUMMARY

There may be a need to form a sample needle, which can be connected to a sample receiving volume, for a sample handling device of an analyzer for analyzing a fluidic sample with low wear.

According to an exemplary embodiment of the present disclosure, a needle arrangement is provided for a sample handling device of an analyzer for analyzing a fluidic sample, wherein the needle arrangement comprises a rotatably mounted sample needle having a lumen for passing fluidic sample therethrough.

According to another exemplary embodiment of the present disclosure, there is provided a sample handling device for handling a fluidic sample in an analyzer for analyzing the fluidic sample, the sample handling device comprising a needle arrangement having the features described above and a moving apparatus on which the needle arrangement is mounted or mountable such that the sample needle is rotatable about its own axis relative to the moving apparatus (wherein said own axis may correspond to the axis of rotation).

According to a further exemplary embodiment of the present disclosure, an analyzer for analyzing a fluidic sample (for example to be injected into a mobile phase) is provided, wherein the analyzer comprises at least one sample handling device having the features described above (for example a first sample handling device as injector and a second sample handling device as fractionator) for handling the fluidic sample.

According to another exemplary embodiment of the present disclosure, a method of operating an analyzer for analyzing a fluidic sample is provided, the method comprising passing fluidic sample through a lumen of a sample needle for transferring the fluidic sample between a sample receiving device and a sample receiving volume fluidically coupled to the sample needle, and rotating the rotatably supported sample needle about its own axis (in particular relative to a needle housing receiving the sample needle and/or relative to a moving apparatus supporting the sample needle).

According to another exemplary embodiment of the present disclosure, a sample handling device is provided for handling a fluidic sample in an analyzer for analyzing the fluidic sample, wherein the sample handling device comprises: i) a sample needle having a lumen for passing the fluidic sample therethrough, and ii) a moving apparatus for moving the sample needle (by means of a rotational movement), wherein the sample needle is rotatably supported relative to the moving apparatus.

According to another exemplary embodiment of the present disclosure, a method is provided for operating an analyzer for analyzing a fluidic sample, the method comprising: i) passing fluidic sample through a lumen of a sample needle for transferring the fluidic sample between a sample receiving device and a sample receiving volume fluidically coupled to the sample needle, ii) (rotationally) moving the sample needle by means of a moving apparatus, and iii) rotating the sample needle relative to the moving apparatus, wherein the sample needle is rotatably supported relative to the moving apparatus.

In the context of the present application, the term “sample handling device” may be understood to mean, in particular, an arrangement which is configured to handle a fluidic sample. For example, such a sample handling device may comprise an injector or a sample delivery unit configured to inject a fluidic sample from an injector path into a separation path for separating the fluidic sample in the separation path. According to another embodiment, such a sample handling device can be a fractionator, with which an already separated fluidic sample can be fractionated, for example filled fraction by fraction into different target containers. Such a sample handling device can have a moving apparatus which can be configured to move the sample needle for handling the fluidic sample to be analyzed (in particular to be separated) or analyzed (in particular separated). However, other sample handling devices are possible.

In the context of the present application, the term “fluid” is understood to mean in particular a liquid and/or a gas, optionally comprising solid particles.

In the context of the present application, the term “fluidic sample” is understood to mean in particular a medium, further in particular a liquid, which contains the matter actually to be analyzed (for example a biological sample), such as a protein solution, a pharmaceutical sample, etc.

In the context of the present application, the term “mobile phase” is understood to mean in particular a fluid, further in particular a liquid, which serves as a carrier medium for transporting the fluidic sample between a fluid drive and a sample separation device. However, mobile phase can also be used in a fluid transportation device to influence the fluidic sample. For example, the mobile phase can be a solvent (e.g. organic and/or inorganic) or a solvent composition (e.g. water and ethanol).

In the context of the present application, the term “analyzer” may in particular designate a device which is capable of and configured for analyzing, in particular separating, a fluidic sample, further in particular separating it into different fractions. For example, such a sample separation can be carried out by means of chromatography or electrophoresis. The analyzer may be a liquid chromatography sample separation device.

In the context of the present application, the term “sample needle” means in particular a hollow body with a lumen or through-hole through which a fluidic sample can be guided. In particular, a fluidic sample can be introduced (e.g. sucked in) into a sample handling device and/or removed (e.g. ejected) from a sample handling device through the lumen or through-hole. A sample needle can be elongated and rotationally symmetrical and can therefore have an axis of symmetry.

In the context of the present application, the term “rotatably mounted sample needle” can be understood in particular to mean a sample needle which can be rotated about its own axis (in particular its own axis of symmetry) during operation. In particular, a rotatably or rotatably mounted sample needle can be configured to perform an endless rotation. Such a sample needle can be rotated through any angle, which can also exceed 360°, when mounted. In particular, a rotatably mounted sample needle can be rotated about its own axis (also referred to as the axis of rotation or axis of symmetry) relative to the rest of the needle arrangement or relative to the rest of the sample handling device.

In the context of the present application, the term “lumen for passing fluidic sample” can be understood in particular to mean a through-hole extending through the sample needle, through which a fluid and in particular a fluidic sample can flow.

In the context of the present application, the term “moving apparatus” can be understood in particular to mean a component or an assembly which can execute a movement (in particular a rotary movement), for example in order to mechanically move another component (for example a sample needle) arranged on the moving apparatus according to the cantilever type. Alternatively or additionally, the moving apparatus can be configured to perform at least one translational and/or rotational movement, for example to vertically raise or lower a component (for example a sample needle).

According to an exemplary embodiment of the present disclosure, a sample needle on a sample handling device can be configured to rotate about its own axis. For example, if the sample needle is mounted on a moving apparatus of the sample handling device and is moved during operation by rotating the moving apparatus, for example between a needle seat and a sample receiving device, the sample needle can at least partially compensate for mechanical loads acting on it by performing a rotational movement about its own axis. As a result, the sample needle and, in particular, a sample receiving volume that can be fluidically connected to the sample needle (for example, a sample loop configured as a capillary) can be reliably protected from excessive mechanical stress or even damage when the sample needle is moved. The sample needle can fully or partially compensate for loads acting on it by means of a compensating movement around its own axis and, in particular, protect the sample receiving volume from high mechanical loads. This can reduce wear on the needle arrangement and consequently increase the service life of the needle arrangement and its components.

Thus, according to an embodiment of the present disclosure, a sample needle of an analyzer can be mounted rotatably about its own needle axis. This can ensure that connections of the sample handling device with such a sample needle are not unduly mechanically loaded by a movement of a moving apparatus and the sample needle coupled thereto, since a rotation bearing of the needle arrangement can allow the sample needle to rotate relative to other components of the sample handling device. In the manner described above, it is possible to move the sample needle to a sample holder (for example, a microtiter plate with more than one hundred samples) to move the sample through the sample needle into a sample receiving volume. Compared to conventional approaches for the low-wear configuration of a sample handling device, exemplary embodiments of the present disclosure have the advantage that a sample receiving volume fluidically coupled to the sample needle can be formed compactly (in particular without stress-absorbing windings). This can reduce the fluidic dead volume, which is advantageous for the operation of an analyzer with such a sample needle.

Additional embodiments of the needle arrangement, the sample handling device, the analyzer and the method are described below.

According to an embodiment, the sample needle is (connected and) fluidically coupled to a sample receiving volume, wherein the rotatable mounting of the sample needle relative to the moving apparatus is configured such that a relative movement between the sample needle and the sample receiving volume is reduced.

According to an embodiment, the needle arrangement can have a needle housing in which a part of the sample needle is mounted such that the needle housing remains stationary in a rotationally fixed manner when the sample needle rotates. For example, the needle housing can be a rigid sleeve coupled to the sample needle, through which a part of the sample needle passes. The sample needle can be mounted so that it can rotate about its own axis relative to the needle housing. Furthermore, the needle housing can, for example, be mounted on a moving apparatus (in particular a rotating arm) of the sample handling device.

According to an embodiment, the sample needle can be mounted on the needle housing in such a way that the needle housing and the sample needle are rigidly coupled to one another in the direction of an axis of rotation of the sample needle. Advantageously, the sample needle can be attached to the needle housing in such a way that the sample needle can rotate around its own axis relative to the needle housing, but is rigidly coupled to the needle housing along its axial extension. If a force is exerted on the sample needle along its axial extension direction, the needle housing moves with the sample needle. This simplifies the movement of the sample needle by means of a moving apparatus, for example moving the sample needle between a needle seat and a sample holding device. This means that the sample needle can be firmly attached to the needle housing, particularly along its axis of rotation, i.e. usually in the vertical or z-direction during operation, and can be moved in the said direction together with the needle housing or with a cantilever arm of a moving apparatus.

Alternatively, the sample needle can be mounted on the needle housing in such a way that the needle housing and the sample needle can be moved relative to one another in the direction of an axis of rotation of the sample needle, in particular in a limited or unlimited manner. According to one such embodiment, the sample needle can also be moved along its axis of rotation, i.e. in operation usually in the vertical or z-direction, relative to the needle housing or to a cantilever arm of a moving apparatus. Such a linear movement along the axis of rotation of the sample needle can either be completely free or can be limited to a range of movement defined on one or both sides. In the latter configuration, for example, a stop can be provided up to which the sample needle can move longitudinally relative to the needle housing or the moving apparatus. By limiting the needle movement in the axial direction in this way, it is possible to prevent the sample needle from striking another body in an undesirable manner and being damaged in the process. The stop or the sample needle may be spring-loaded in order to avoid excessive force when the sample needle strikes.

According to an embodiment, the sample needle may have no further degree of freedom of movement relative to the needle housing in addition to its rotatability. The rotation of the sample needle about its own axis can thus be the only degree of freedom of the sample needle for performing a movement relative to the needle housing or relative to the moving apparatus. With regard to all other degrees of freedom of movement, the sample needle then moves rigidly with the needle housing or the moving apparatus.

According to an embodiment, the needle arrangement can have a rotation bearing for rotatably supporting the sample needle. In particular, a rotation bearing can be understood to mean a bearing that allows the sample needle to rotate about its own axis, in particular only allows the sample needle to rotate about its own axis.

According to an embodiment, the rotation bearing can be arranged between the needle housing and the sample needle. Thus, an annular rotation bearing can be arranged in an annular space between the sample needle and a hollow cylindrical needle housing.

According to an embodiment, the rotation bearing can be an outer bearing. This means that the rotation bearing can extend around an outer circumference of the sample needle. Such a configuration is particularly well suited to the requirements of a sample needle for an analyzer. According to another embodiment, the rotation bearing can be an inner bearing. A slide bearing can be formed between the sample needle and the needle housing, for example in the form of a rotary coupling. For example, an annular protrusion (e.g. an O-ring) can be provided on a lateral surface of the sample needle, which is inserted into a corresponding annular groove of the needle housing or moving apparatus when mounted on a needle housing or directly on a robot arm of a moving apparatus. The annular protrusion of the sample needle then rotates relative to the needle housing or moving apparatus during operation.

According to an embodiment, the rotation bearing can be configured as a rolling bearing. The term “rolling bearing” can designate bearings in which rolling bodies between an inner ring and an outer ring reduce the frictional resistance. For example, the rolling bodies can be balls, wherein the rolling bearing is configured as a ball bearing. As an alternative to a rolling bearing, it is also possible to configure the rotation bearing as a slide bearing, in which a bearing can be achieved by lubrication. It is also possible for the rotation bearing to be configured as a fluid bearing, air bearing and/or magnetic bearing.

According to an embodiment, the rotation bearing can have a first bearing stage and a second bearing stage spaced apart from the first bearing stage in the axial direction of the sample needle. Thus, the two (or more than two) bearing stages may be axially spaced from each other and thereby also guide the sample needle. For example, each of the bearing stages can be configured as a rolling bearing stage. Alternatively, the rotation bearing can have a single bearing stage.

According to one embodiment, the needle arrangement can be configured to be high-pressure robust. In the context of the present application, the term “high-pressure robust” can be understood in particular to mean a needle arrangement that can be operated under high-pressure conditions and in long-term operation without damage or destruction. In particular, “high-pressure robust” can be understood to mean a needle arrangement that can withstand pressures of up to 200 bar, in particular up to 600 bar and preferably up to 1200 bar or more, without being damaged or destroyed during long-term operation. In particular, such a high-pressure robust or high-pressure resistant needle arrangement can be configured for operation in an HPLC. For example, to make a needle arrangement resistant to high pressure, wall thicknesses can be formed with such a thickness that they can withstand the high pressures. In addition, a high-pressure robust configuration of a needle arrangement also implies a configuration of the needle arrangement made of correspondingly pressure-robust materials. In the case of a high high-pressure robust configuration of a needle arrangement, fluid-tightness of the fluid conveying device under the aforementioned high pressures can also be achieved by appropriate sealing measures. A high-pressure robust needle arrangement may also be configured in such a way that it is compatible with aggressive chemicals (for example organic solvents) and is not attacked by such aggressive chemicals. Therefore, the needle arrangement can also be configured to cope with harsh solvents.

A high-pressure robust configuration of the needle arrangement can in particular include a high-pressure robust configuration of a sample receiving volume of the needle arrangement. A high-pressure robust sample receiving volume can be configured in particular as a metallic capillary (such as a stainless steel capillary), which can, however, tend to be brittle and can thus break under excessive mechanical stress. By making the sample needle of the needle arrangement freely rotatable, the sample receiving volume fluidically connected to the sample needle can also be protected from excessive mechanical stress when the sample needle is moved. Advantageously, a rotatably mounted sample needle can move relative to a moving apparatus (for example a robot), whereas relative movements between the sample needle and the sample volume are strongly suppressed.

According to an embodiment, the needle arrangement can have a sample receiving volume fluidically coupled to the sample needle, in particular a sample loop. In particular, this can be understood to mean a capillary piece in the interior of which a receiving volume is formed for receiving a defined quantity of fluidic sample.

According to an embodiment, the needle arrangement can have a fitting for fluidic coupling of the sample needle with the sample receiving volume. In particular, the fitting can be configured as a high-pressure fitting that couples the sample needle to the sample receiving volume in such a way that fluid can flow between the sample needle and the sample receiving volume without leakage even at high pressures (for example, at least 600 bar, in particular at least 1200 bar).

According to an embodiment, the sample needle may have no further degree of freedom of movement relative to the moving apparatus in addition to its rotatability. Thus, when the needle arrangement is mounted to the moving apparatus, the sample needle is rigidly entrained with the moving apparatus, wherein the free rotatability of the sample needle relative to the moving apparatus may also be the only exception to the rigid coupling between the sample needle and the moving apparatus. This allows mechanical relief between the sample needle and the sample receiving volume by compensating the rotation of the sample needle while maintaining precise motion control of the sample needle.

According to an embodiment, a needle housing of the needle arrangement can be rigidly attached to the moving apparatus. While a rotation bearing between the needle housing and the sample needle allows the sample needle to rotate freely, in one embodiment the rotation bearing can cause the sample needle to move with the needle housing or with a moving apparatus in other (in particular all other) movement modes.

According to an embodiment, the sample handling device can be configured as an injector for injecting the fluidic sample to be analyzed from an injector path of the sample handling device into a separation path of the analyzer. In the context of the present application, the term “injector” can be understood in particular to mean an apparatus with which a fluidic sample can first be received into a sample receiving volume and subsequently introduced into a separation path between the fluid drive and the sample separation device by switching an injection valve accordingly. A fluidic path associated with such an injector can be referred to as an injector path. In the context of the present application, the term “fluid drive” can be understood in particular to mean a device for conveying mobile phase and fluidic sample. In particular, the fluid drive can be a piston pump. The fluid drive can be configured as a fluid pump for generating a high pressure (for example at least 1000 bar) for conveying the mobile phase and fluidic sample during analysis. The fluid drive can be configured as an analytical pump in the analyzer. In the context of the present application, the term “sample separation device” can be understood in particular as a device for analyzing a fluidic sample, in particular into different fractions. For this purpose, components of the fluidic sample can first be adsorbed on the sample separation device and then desorbed separately (in particular fraction by fraction). For example, such a sample separation device can be configured as a chromatographic separation column.

According to another embodiment, the sample handling device may be configured as a fractionator for fractionating the fluidic sample into a fractionation target. A fractionator can vividly dispense a fluidic sample separated into fractions into different fractionating containers, each of which can be infested with at least one fraction, for example. For this purpose, the separated fluidic sample can be transferred into the fractionating containers by a sample needle.

According to an embodiment, an analyzer may have a first sample handling device for an injector and a second sample handling device for a fractionator, both of which may be equipped with a rotatably mounted sample needle. It is also possible to operate a single sample handling device selectively as an injector or fractionator.

According to an embodiment, the sample handling device may comprise a fluid conveying device configured to draw the fluidic sample from a sample receiving device (for example a sample source, a sample container, a sample plate with multiple sample receptacles, etc.) through the sample needle into a sample receiving volume of the needle arrangement. In the context of the present application, the term “fluid conveying device” can be understood in particular to mean a device which is configured to move a fluid (for example a solvent or a solvent composition or a fluidic sample to be analyzed). In particular, such a fluid conveying device can be configured for drawing in a fluid along a first flow direction and for subsequently ejecting the fluid along a flow direction antiparallel thereto.

According to an embodiment, the fluid conveying device can be configured as a dosing (or metering) device for dosing (or metering) a fluidic sample. The fluid conveying device can then be operated to draw a predetermined amount of the fluidic sample into a sample receiving volume between the fluid conveying device and a sample needle and subsequently inject it.

According to an embodiment, the sample needle and the fluid conveying device can be fluidically coupled to each other. Thus, a fluid, such as a fluidic sample and/or a mobile phase, can be guided unidirectionally or bidirectionally through the sample needle under the control of a corresponding operation of the fluid conveying device.

According to an embodiment, a sample receiving volume can be arranged between the sample needle and the fluid conveying device, which is configured to receive the fluidic sample when the sample needle is immersed in fluidic sample and a piston of the fluid conveying device is moved. In particular, the fluid conveying device can be configured to draw the fluidic sample through the sample needle into the sample receiving volume by moving the piston. For this purpose, a piston of the fluid conveying device can be moved backwards.

According to an embodiment, the fluid conveying device can be configured for injecting a drawn-in fluidic sample from the sample receiving volume into a separation path of the analyzer. For this purpose, a piston of the fluid conveying device can be moved forward.

According to an embodiment, the sample handling device can have a needle seat into which the sample needle can be inserted in a fluid-tight (or additionally high-pressure robust) manner by moving the moving apparatus (for example by rotating a moving apparatus configured as a rotary arm) in order to guide fluidic sample through the sample needle and through the needle seat. When the sample needle is inserted into the needle seat, previously sucked fluidic sample can be transferred into a separation path of the analyzer for separation.

According to an embodiment, an analyzer configured as a sample separation device may comprise, as a sample handling device, an injector for injecting the fluidic sample into the mobile phase, a fluid drive for driving the mobile phase and the fluidic sample injected into the mobile phase, and a sample separation device for analyzing the fluidic sample injected into the mobile phase. For example, a corresponding analysis device can be configured as a liquid chromatography sample separation device, in particular as an HPLC.

The analyzer can be a microfluidic meter, a life science device, a liquid chromatography device, a gas chromatography device, an HPLC (High Performance Liquid Chromatography) device, a UHPLC (Ultra High Performance Liquid Chromatography) device or an SFC (Supercritical Fluid Chromatography) device. However, many other applications are possible.

According to one embodiment, the sample separation device can be configured as a chromatographic separation device, in particular as a chromatographic separation column. In the case of a chromatographic separation, the chromatography separation column can be provided with an adsorption medium. The fluidic sample can be retained on this and only subsequently released fraction by fraction in the presence of a specific solvent composition, thus separating the sample into its fractions.

A pump system for pumping fluid can, for example, be set up to convey the fluid or the mobile phase through the system at a high pressure, for example several 100 bar up to 1000 bar and more.

The analyzer may have a sample injector for introducing the sample into the fluidic separation path. Such a sample injector may have a sample or injection needle that can be coupled to a needle seat in a corresponding fluid path, wherein the sample needle can be moved out of this needle seat to receive sample. After the sample needle has been reinserted into the needle seat, the sample can be located in a fluid path which can be switched into the separation path of the system, for example by switching a valve. In another embodiment of the present disclosure, a sample injector or sampler can be used with a sample needle that is operated without a needle seat.

The analyzer may have a fraction collector for collecting the separated components. Such a fraction collector can, for example, feed the various components of the separated sample into different liquid containers. However, the analyzed sample can also be fed to a discharge container.

The analyzer may comprise a detector for detecting the separated components. Such a detector can generate a signal which can be observed and/or recorded, and which is indicative of the presence and amount of the sample components in the fluid flowing through the system.

### BRIEF DESCRIPTION OF THE FIGURES

Other objectives and many of the attendant advantages of embodiments of the present disclosure will become readily perceived and better understood with reference to the following more detailed description of embodiments in connection with the accompanying drawings. Features which are substantially or functionally the same or similar are designated by the same reference signs.

FIG. 1 shows an HPLC system according to an exemplary embodiment of the present disclosure.

FIG. 2 shows a sample handling device configured as an injector according to an exemplary embodiment of the present disclosure.

FIG. 3 shows a cross-sectional view of a needle arrangement for a sample handling device of a sample separation device for separating a fluidic sample according to an exemplary embodiment of the present disclosure.

FIG. 4 shows a top view of the needle arrangement according to FIG. 3.

FIG. 5 shows a cross-sectional view of a sample handling device according to an exemplary embodiment of the present disclosure.

FIG. 6 shows a cross-sectional view of a needle arrangement for a sample handling device of a sample separation device for separating a fluidic sample according to another exemplary embodiment of the present disclosure.

FIG. 7 shows a cross-sectional view of a needle arrangement for a sample handling device of a sample separation apparatus for separating a fluidic sample according to still another exemplary embodiment of the present disclosure.

FIG. 8 shows a three-dimensional view of a sample handling device according to an exemplary embodiment of the present disclosure.

The illustrations in the drawings are schematic.

### DETAILED DESCRIPTION

Before exemplary embodiments are described with reference to the figures, some basic considerations will be summarized, based on which exemplary embodiments of the present disclosure have been derived.

According to an exemplary embodiment of the present disclosure, a needle arrangement for a sample handling device (such as an injector) of a sample separation device (for example, a liquid chromatography device) can be equipped with a sample needle mounted to rotate about its own axis. A needle holder can thus be provided with an axis of rotation around which the sample needle can rotate freely. This allows automatic compensation of mechanical loads that can act on the sample needle or a sample receiving volume connected to it when the sample needle is moved during sample handling operation. This reduces wear on the components of the needle arrangement and thus increases its service life. In particular, a mechanical load resulting from the rotation of a moving apparatus of a sample handling device carrying the sample needle on a sample receiving volume configured as a capillary can thus be at least partially compensated.

Traditionally, injection needles in liquid chromatography can be firmly connected to an associated robot. This inhibits all degrees of freedom between the robot and the sample needle. However, the conventional fixed connection between robotics and injection needle has the disadvantage that the sample collection volume (in particular a capillary) experiences the movements of the sample needle to the full extent. This conventionally leads to accelerated wear of the sample collection volume.

In order to overcome these and/or other disadvantages in whole or in part, according to an exemplary embodiment of the present disclosure, a needle which is firmly installed or firmly clamped in the z-direction is equipped with the degree of freedom of rotation about the z-direction. In this context, the z-direction can be understood as an axial direction, symmetry axis or the sample needle's own axis, which can also correspond to a vertical direction.

The rotatable mounting of a sample needle relative to a needle housing and/or a moving apparatus has advantages: The rotatably mounted sample needle can greatly reduce the relative, in particular rotational, movements between the sample receiving volume, which is formed in particular as a sample loop or sample capillary, and the sample needle. As a result, the mechanical stress acting on the sample collection volume can be significantly reduced. Consequently, the risk of breakage of the sample loop can be reduced and the service life of the needle arrangement can be increased.

Apart from an achievable increased service life of the sample receiving volume, this can also be produced with a simplified configuration according to an exemplary embodiment of the present disclosure. Since winding of the capillary for mechanical relief of the sample receiving volume is no longer absolutely necessary according to an exemplary embodiment of the present disclosure, a fluidic dead volume can be reduced, thereby improving the analysis by the analyzer. Furthermore, according to embodiments of the present disclosure, greater degrees of freedom are possible in the development of robotics of the sample handling device. In particular, such robotics, which may comprise the moving apparatus described above, can accomplish more complex and/or larger movements without generating excessive mechanical loads. In addition, a kind of spring effect can be generated, which can result in a reduced influence of the sample receiving volume on the movement of the robotics.

According to an exemplary embodiment of the present disclosure, a sample needle (in particular of an HPLC injector) can thus be provided with a rotation bearing that can enable rotation of the sample needle with respect to its bearing. In particular, a rotor bearing can be provided for the sample needle which can be moved and/or operated by a robotic arm (such as a moving apparatus).

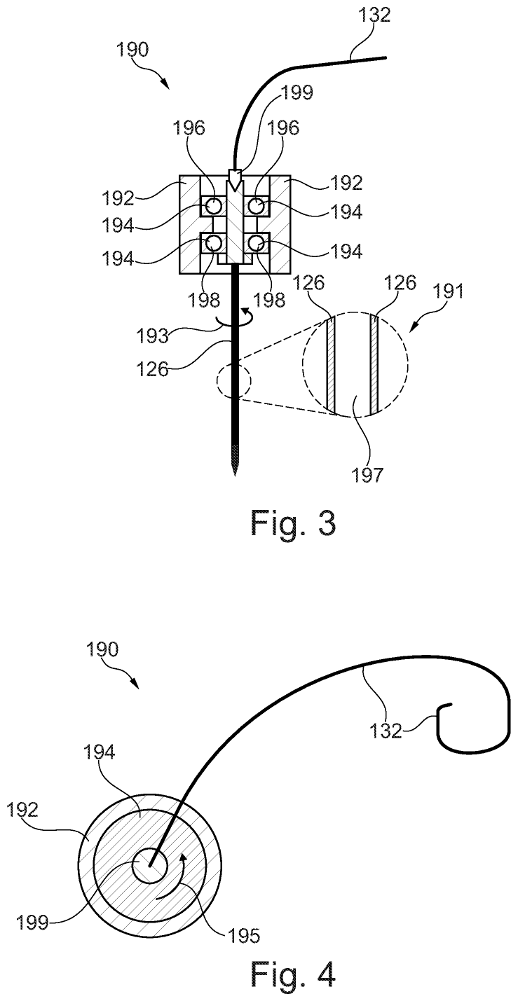

A rotation bearing for rotatable storage of the sample needle can be in particular an inner bearing (for example with an O-ring for sealing) and/or an outer bearing (the latter is shown in FIG. 3 and FIG. 4). In addition, a fitting can be used to couple the sample collection volume (in particular a sample collection capillary) to the sample needle. Such a fitting can also fluidically couple the sample needle to any other component located behind the sample collection volume.

In particular, the rotation bearing for the sample needle may be configured to allow the exertion or transmission of an axial force on the sample needle, which may be beneficial for the operation of the sample needle. Embodiments of the present disclosure are particularly useful for handling the rotary needle using a robotic mechanism, wherein the sample needle is moved by rotation or pivoting. However, embodiments of the present disclosure may also be equipped with one-dimensional or two-dimensional linear drive mechanisms in which the sample needle is moved in operation along, for example, a horizontal direction or in, for example, a horizontal plane. Rotary or linear axes can be provided in one, two or three dimensions, and all possible combinations of both.

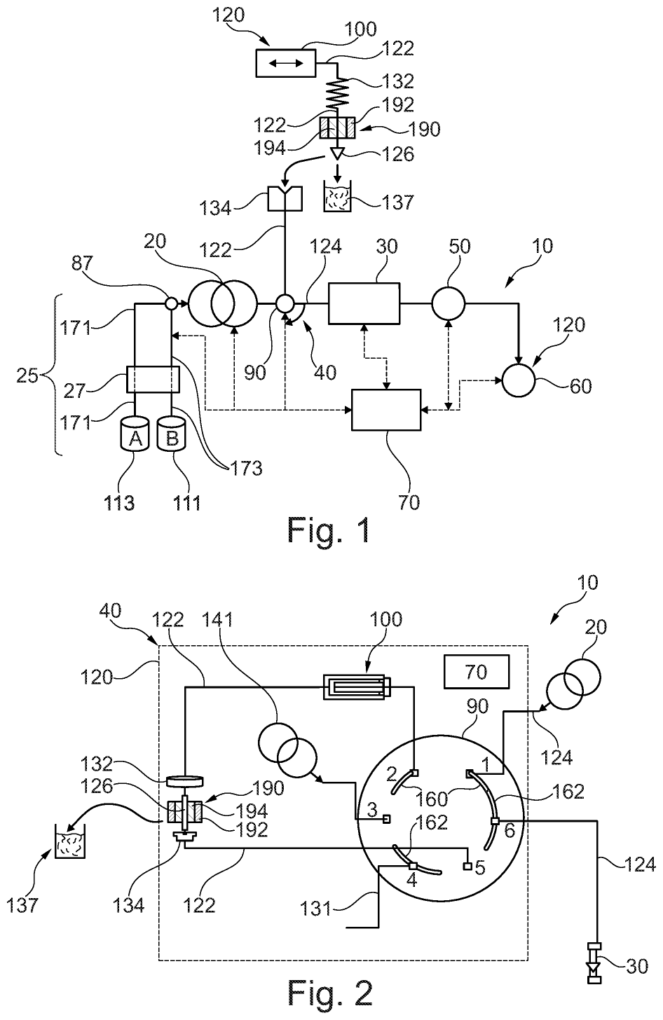

FIG. 1 shows the basic structure of an HPLC system as an example of an analyzer 10 configured as a sample separation device according to an exemplary embodiment of the present disclosure, such as can be used for liquid chromatography. A fluid conveying device or fluid drive 20, supplied with solvent from a supply (or feed) device 25, drives a mobile phase through a sample separation device 30 (such as a chromatographic column) containing a stationary phase. The feed device 25 comprises a first fluid component source 113 for providing a first fluid or solvent component A (for example, water) and a second fluid component source 111 for providing another second fluid or solvent component B (for example, an organic solvent). An optional degasser 27 can degas the solvents provided by means of the first fluid component source 113 and by means of the second fluid component source 111 before they are supplied to the fluid drive 20. A sample delivery unit, which may also be referred to as an injector 40, is disposed between the fluid drive 20 and the sample separation device 30 to initially receive a sample fluid or fluidic sample from a sample receiving device 137 (for example, a sample container) into a sample receiving volume 132 in an injector path 122 (shown only schematically), and subsequently introduce it into a fluidic separation path 124 between the fluid drive 20 and the sample separation device 30 by switching an injection valve 90 of the injector 40. Fluidic sample can be picked up from the sample receiving device 137 in particular by moving a sample needle 126 out of a sample needle seat 134 and into the sample container or the sample receiving device 137, sucking fluidic sample from the sample container or the sample receiving device 137 through the sample needle 126 into the sample receiving volume 132 by means of a fluid conveying device 100 configured as a dosing (or metering) device, and then moving the sample needle 126 back into the needle seat 134.

The stationary phase of the sample separation device 30 is intended to separate components of the sample. A detector 50, which may comprise a flow cell, detects separated components of the sample. A fractionation device or fractionator 60 can be provided to dispense separated components of the sample into containers provided for this purpose. Liquids that are no longer required can be discharged into a discharge container or into a waste line 131 (see FIG. 2).

While a fluid path between the fluid drive 20 and the sample separation device 30 is typically under high pressure, the sample fluid under normal pressure is first introduced into an area separate from the fluid path, namely the sample loop or sample receiving volume 132, of the sample introduction unit or injector 40. The sample liquid is then introduced into the high-pressure separation path 124. A sample loop as the sample receiving volume 132 (also referred to as a sample loop) can be understood as a section of a fluid line that is configured to receive or temporarily store a predetermined amount of fluidic sample. In an embodiment, even before the sample fluid in the sample receiving volume 132, which is initially under normal pressure, is switched into the high-pressure separation path 124, the contents of the sample receiving volume 132 are brought to the system pressure of the analyzer 10, which is configured as an HPLC, by means of a dosing (or metering) device in the form of the fluid conveying device 100. A control device 70 controls the individual components 20, 25, 30, 40, 50, 60, 90, etc., of the analyzer 10.

FIG. 1 shows two feed lines 171, 173, each of which is fluidically coupled to a respective one of the two solvent containers designated as fluid component sources 113, 111 for providing a respective one of the fluids or solvent components A and B, respectively. The respective fluid or the respective solvent component A or B is conveyed through the respective feed line 171 or 173, through the degasser 27 to a proportioning valve 87 as a proportioning device, at which the fluids or solvent components A or B from the feed lines 171, 173 are combined with one another. At the proportioning valve 87, the fluid packets from the feed lines 171, 173 thus flow together by forming a homogeneous solvent composition mixture. The latter is then fed to the fluid drive 20.

In operation of the analyzer 10, and in particular the injector 40, the injection valve 90 is switched by the control device 70 to inject a fluidic sample from the sample receiving volume 132 into a mobile phase in the separation path 124 between the fluid drive 20 and the sample separation device 30 of the analyzer 10. This switching of the injection valve 90 is performed to effect relative movement between a first valve body (which may be a stator at rest with respect to a laboratory system) and a second valve body (which may be a rotor rotatable with respect to the laboratory system) of the injection valve 90. The first valve body may be provided with a plurality of ports and optionally with one or more groove-like connecting structures. The second valve body, on the other hand, can be provided with one or several groove-shaped connecting structures in order to thereby selectively fluidically couple or decouple respective ones of the ports of the first valve body depending on a respective relative orientation between the first valve body and the second valve body by means of the at least one connecting structure of the second valve body. Illustratively, in certain switching states of the injection valve 90, a respective groove-shaped connecting structure of the second valve body can fluidically connect two (or more) of the ports of the first valve body to each other and form a fluidic decoupling between other of the ports of the first valve body. In this way, the individual components of the sample separation device 90 can be brought into an adjustable fluidic (de)coupling state with one another depending on a respective operating state of the injector 40.

In the analyzer 10 shown in FIG. 1, two sample handling devices 120 are provided for handling the fluidic sample. A first sample handling device 120 serves as an injector 40 for injecting the fluidic sample into the mobile phase. A second sample handling device 120 may be implemented in the fractionator 60 for fractionating separate fractions of the fluidic sample.

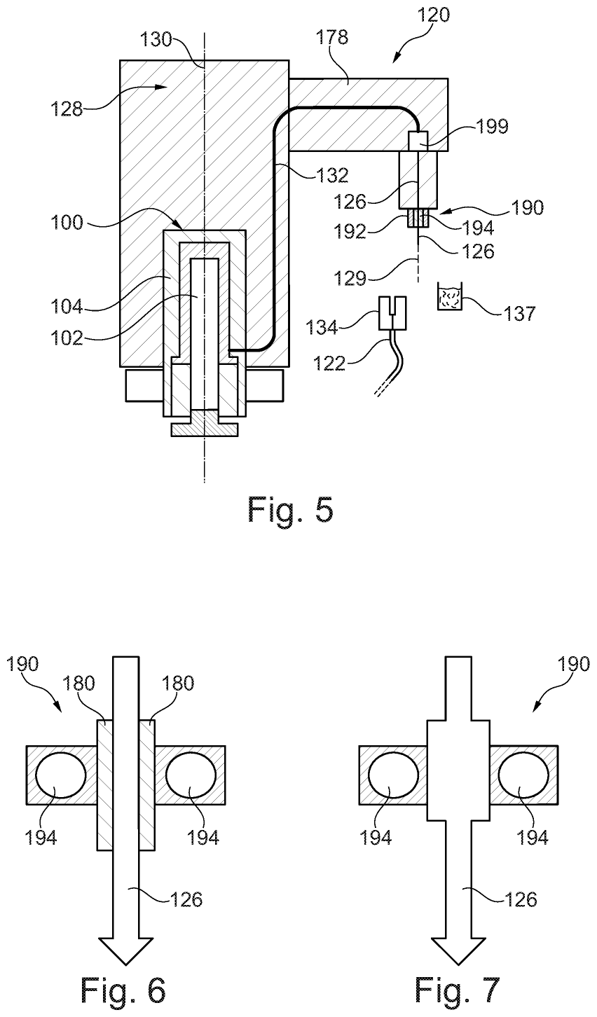

Said first sample handling device 120 is shown in more detail in FIG. 1. This has a needle arrangement 190. Furthermore, the respective sample handling device 120 may have a moving apparatus 128 shown in FIG. 5, in particular a rotating arm. The needle arrangement 190 can be mounted on the moving apparatus 128 in such a way that the sample needle 126 of the needle arrangement 190 can rotate freely relative to the moving apparatus 128. Thus, a rotatably mounted sample needle 126 for passing fluidic sample is implemented on the needle arrangement 190. The needle arrangement 190 has a needle housing 192, in which an axial section of the sample needle 126 is mounted by means of a rotation bearing 194 in such a way that rotation of the sample needle 126 relative to the needle housing 192 is possible. The needle housing 192 thus remains stationary in a rotationally fixed manner when the sample needle 126 rotates in its interior about its central axis. The free rotatability of the sample needle 126 about its own axis allows the sample receiving volume 132, which is formed as a sample loop, to be protected from mechanical damage when the sample needle 126 is moved by the moving apparatus 128 not shown in FIG. 1 (see FIG. 5). Illustratively, the sample needle 126 can then perform a rotational compensatory movement that can reduce mechanical loads and can thereby protect the sample receiving volume 132 from mechanical damage.

FIG. 2 shows an injector 40 of an analyzer 10 according to an exemplary embodiment of the present disclosure.

An injection valve 90 is installed in a liquid chromatography analyzer 10 for separating a fluidic sample. As shown in FIG. 2, the analyzer 10 has a fluid drive 20 configured as a high-pressure pump for driving a mobile phase (i.e., a solvent or a solvent composition) and a fluidic sample to be injected into the mobile phase by means of the injector 40. The fluidic sample is to be separated into its fractions by means of the analyzer 10. The actual separation takes place by means of the sample separation device 30, which is configured as a chromatographic separation column, after the fluidic sample has been injected into the mobile phase.

Here, the injection valve 90 of the injector 40 shown in FIG. 2 serves to inject the fluidic sample into the mobile phase in a separation path 124 between the fluid drive 20 and the sample separation device 30. For this purpose, the injector 40 has a sample receiving volume 132, for example configured as a sample loop, for receiving a predeterminable volume of the fluidic sample. Furthermore, the injector 40 shown in FIG. 2 includes a dosing (or metering) device, for example in the form of a syringe pump with a movable piston, in the form of the fluid conveying device 100 for dosing (or metering) the fluidic sample to be received in the sample receiving volume 132. A waste line 131 is used to discharge fluid that is no longer required, for example a rinsing liquid, mobile phase that is no longer required, or fluidic sample that is no longer required.

Furthermore, the injector 40 has a movable needle 126 which, according to FIG. 2, is received in a fluid-tight manner in a needle seat 134 for receiving the needle 126 in a fluid-tight manner. In addition, the needle 126 can also be moved out of the needle seat 134 and inserted into a sample container as a sample receiving device 137 with fluid sample in order to then draw fluid sample from the sample receiving device 137 through the needle 126 into the sample receiving volume 132 by moving back the piston of the fluid conveying device 100, which is configured as a dosing (or metering) device. Movement of the needle 126 between the needle seat 134 and the sample receiving device 137 may be accomplished by means of a moving apparatus (in particular by means of a robotic arm, which may be a rotating arm), which is not shown in FIG. 2 and which is shown in FIG. 5 with reference sign 128.

The injection valve 90 configured as a rotor valve in the illustrated embodiment has stationary ports or fluid connections labeled 1 to 6, some of which are connected to stationary grooves 160. Rotatable grooves 162 are provided opposite these stationary ports 1 to 6 or stationary grooves 160, so that different fluid connection paths can be set.

According to FIG. 2, an additional fluid drive 141 (for example configured as a flushing pump) is provided.

FIG. 3 shows a cross-sectional view of a needle arrangement 190 for a sample handling device 120 of an analyzer 10 for separating a fluidic sample according to an exemplary embodiment of the present disclosure, for example usable according to FIG. 1 or FIG. 2. FIG. 4 shows a top view of the needle arrangement 190 according to FIG. 3.

The needle arrangement 190 shown in FIG. 3 and FIG. 4 has a rotatably mounted sample needle 126, through the central lumen 197 of which a fluid, such as a fluidic sample, can be passed. The lumen 197 is shown in a detail 191 in FIG. 3. A free rotatability of the sample needle 126 relative to a needle housing 192 is shown in FIG. 3 by a rotation arrow 193 and in FIG. 4 by a rotation arrow 195. The sample needle 126 can be rotated about an axis of rotation which is aligned vertically to the paper plane as shown in FIG. 3 and perpendicularly to the paper plane as shown in FIG. 4.

FIG. 3 and FIG. 4 further show that the needle arrangement 190 has a sleeve-shaped needle housing 192, through the central through-hole of which the sample needle 126 extends axially. A partial section of the sample needle 126 is thus mounted inside the needle housing 192. This bearing can be realized by an annular rotation bearing 194 between the sample needle 126 on its inner side and the needle housing 192 on its outer side. This configuration ensures that the sample needle 126 can be rotated. Furthermore, this ensures that the needle housing 192 remains rotationally stationary when the sample needle 126 is rotated. In this way, the sample needle 126 can rotate around its own axis and thereby perform compensatory movements in order to balance or mitigate mechanical loads on connected components (in particular a sample receiving volume 132 formed as a sample loop). This can reduce wear and tear and increase the service life of the needle arrangement 190.

In addition, the sample needle 126 is advantageously mounted on the needle housing 192 in such a way that the needle housing 192 and the sample needle 126 are rigidly coupled to each other in the direction of the axis of rotation of the sample needle 126. Thus, when the needle arrangement 190 moves vertically according to FIG. 3, the needle housing 192 follows the sample needle 126 and vice versa. The same applies to horizontal movements of the needle arrangement 190 in the paper plane of FIG. 4. Thus, according to FIG. 3 and FIG. 4, the sample needle 126 has no further degree of freedom of movement relative to the needle housing 192 in addition to its rotatability about its own axis. Needle housing 192 and sample needle 126 are therefore rigidly coupled to each other with respect to all modes of movement, with the exception of the free rotatability of sample needle 126 about its own axis.

The aforementioned rotation bearing 194 is used for rotatably supporting the sample needle 126. According to FIG. 3 and FIG. 4, the rotation bearing 194 is arranged radially between the needle housing 192 and the sample needle 126 and is configured as an outer bearing. The rotation bearing 194 is configured as a rolling bearing, more specifically as a pair of axially spaced ball bearings. In other words, the rotation bearing 194 has a first bearing stage 196 configured as a first ball bearing and a second bearing stage 198 spaced from the first bearing stage 196 in the axial direction of the sample needle 126 and configured as a second ball bearing. In this way, the rotation bearing 194 fulfills a bearing and guiding function.

Advantageously, the needle arrangement 190, and in particular its sample receiving volume 132 formed here as a stainless steel capillary, can be configured to be high-pressure robust, so that fluidic sample can be passed through the sample needle 126 even under high pressure of 1200 bar or more without damage or leakage occurring. The brittleness of the stainless steel capillary is not a problem, since the free rotatability of the sample needle 126 reduces mechanical loads acting on the sample receiving volume 132.

FIG. 3 and FIG. 4 further show a high-pressure capable fitting 199 that is used to fluidically couple the sample needle 126 to the sample receiving volume 132.

FIG. 5 shows a cross-sectional view of a sample handling device 120 according to an exemplary embodiment of the present disclosure. This can, for example, be equipped with a needle arrangement 190 according to FIG. 3 and FIG. 4.

The sample handling device 120 shown in FIG. 5 includes the hollow sample needle 126 for passing a fluid sample therethrough. Depending on the operation of the fluid conveying device 100, the sample needle 126 may be configured to pass a fluidic sample in both directions. The fluid conveying device 100 is used to convey the fluidic sample through the sample needle 126 by moving a movable piston (or plunger) 102. In the fluid conveying device 100 according to FIG. 5, the piston 102 moves in a piston housing (or chamber) 104 accommodating the piston 102. The sample needle 126 and the fluid conveying device 100 are fluidically coupled to one another for conveying the fluidic sample. The sample receiving volume 132 (for example, formed as a flexible capillary) is disposed between the sample needle 126 and the fluid conveying device 100 and is configured to receive the fluidic sample when the sample needle 126 is immersed in fluidic sample and the piston 102 is moved backward. The fluid conveying device 100 thus serves to draw the fluidic sample through the sample needle 126 into the sample receiving volume 132 by moving the plunger 102.

In addition, the sample handling device 120 according to FIG. 5 has a moving apparatus 128 configured as a rotating arm for rotating the sample needle 126 about an axis of rotation 130. The moving apparatus 128, which is configured as a rotating arm, is coupled to the sample needle 126 via a cantilever arm 178. According to FIG. 5, the needle arrangement 190 can be mounted on the moving apparatus 128. This mounting can be such that the sample needle 126 is freely rotatable about its own axis relative to the moving apparatus 128. Furthermore, according to FIG. 5, the sample needle 126 has no further degree of freedom of movement relative to the moving apparatus 128. A needle housing 192 of the needle arrangement 190 is rigidly attached to the moving apparatus 128. Consequently, the sample needle 126 can rotate relative to the needle housing 192 about its own axis of rotation 129, whereas the sample needle 126 follows a rotation about the axis of rotation 130 of the moving apparatus 128. All other modes of movement other than rotation about its own axis of rotation 129 (for example a vertical movement) can also only be performed by the sample needle 126 together with the other components of the moving apparatus 128.

As further shown in FIG. 5, the sample handling device 120 further comprises a needle seat 134 into which the sample needle 126 is insertable in a fluid-tight manner by moving the moving apparatus 128 to guide fluidic sample through the needle seat 134.

In that the moving apparatus 128 is configured to rotate the sample needle 126 including the needle housing 192 about the axis of rotation 130 and the sample needle 126 is additionally configured to rotate solely about its own axis of rotation 129, the sample receiving volume 132 is subjected to no or no significant mechanical stress when the moving apparatus 128 is rotated to transfer the sample needle 126 between the sample receiving device 137 (for sucking fluidic sample into the injector path 122) and the needle seat 134 (for injecting sucked fluidic sample into a separation path 124).

In particular, in the sample handling device 120, the sample needle 126 may occupy one of two positions, i.e., disposed on the sample vial or sample holding device 137 or on the needle seat 134. The sample vials are often located at many different positions (for example, a microtiter plate). Therefore, the moving apparatus 128 may rotate to immerse the sample needle 126 into the vessels or introduce into the needle seat 134. The sample needle 126 can reach a three-dimensional space, which can be determined by the number of plates and their height. This can be made possible by rotational or linear axes of movement, or by a combination of the two.

FIG. 6 shows a cross-sectional view of a needle arrangement 190 for a sample handling device 120 of an analyzer 10 for separating a fluidic sample according to another exemplary embodiment of the present disclosure, which can be used, for example, according to FIG. 1, FIG. 2 or FIG. 5. According to FIG. 6, the sample needle 126 is inserted into a sleeve 180 or a tube or a grommet) as a needle receptacle, which in turn has been inserted into a central through hole of a rotation bearing 194, for example formed as a ball bearing. The sample needle 126 can thus rotate freely during operation. According to FIG. 6, the rotation bearing 194 has a single bearing stage. The rotation bearing 194 together with the sleeve 190 can be incorporated into a robotic arm (not shown in FIG. 6) of a moving apparatus 128. In other words, a moving apparatus 128 can be equipped with a rotation bearing 194 and a sleeve 180. Prior to operation, the sample needle 126 then only needs to be inserted into the sleeve 180 of the robot arm (for example a cantilever arm 178) and is then rotationally mounted relative to the robot arm.

FIG. 7 shows a cross-sectional view of a needle arrangement 190 for a sample handling device 120 of an analyzer 10 for separating a fluidic sample according to yet another exemplary embodiment of the present disclosure, which can be used, for example, according to FIG. 1, FIG. 2 or FIG. 5. One difference between the embodiment according to FIG. 7 and the embodiment according to FIG. 6 is that according to FIG. 7, the sample needle 126 forms an integral part of a rotation bearing 194. The needle arrangement 190 comprising sample needle 126 and rotation bearing 194 according to FIG. 7 can thus be inserted as a whole into a robot arm (for example a cantilever arm 178) and is then rotatably mounted relative to the robot arm. As illustrated in FIG. 7, a needle body forms part of a bearing body. In other words, a needle body can contain a bearing body, or a part of a bearing body, or be formed integrally therewith.

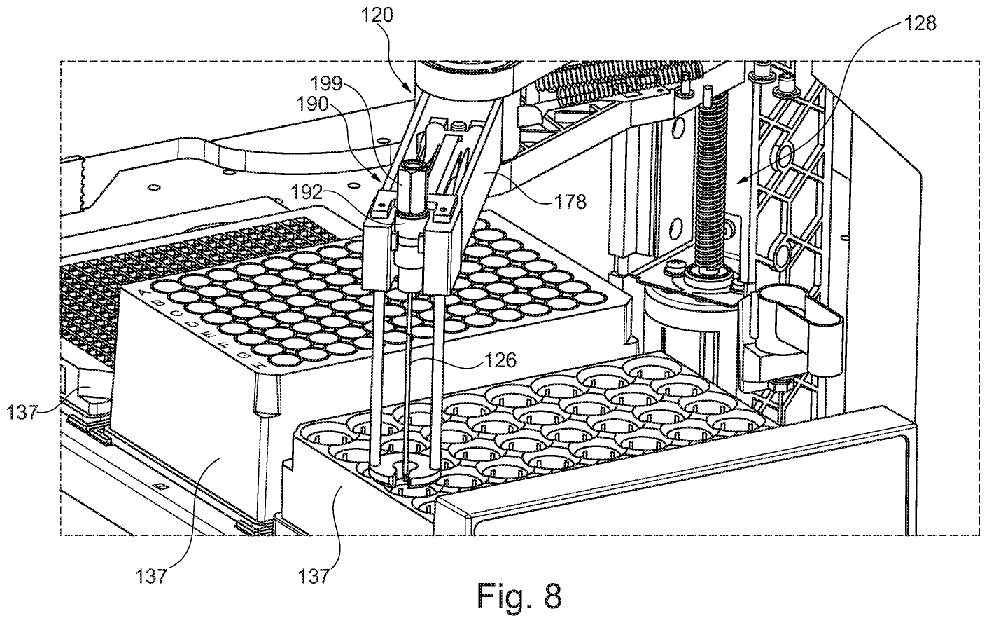

FIG. 8 shows a three-dimensional view of a sample handling device 120 according to an exemplary embodiment of the present disclosure, which is equipped with a needle arrangement 190.

According to FIG. 8, fluidic samples are handled from a respective sample receiving device 137, which are configured here as microtiter plates. In order to pick up a fluidic sample from a sample pick-up well or from a sample container in the sample receiving device 137, the sample needle 126 is moved by means of the illustrated moving apparatus 128 to the fluidic sample to be picked up at a corresponding position of the sample receiving device 137. As shown in FIG. 8, a needle housing 192 of the rotationally mounted sample needle 126 is picked up by a cantilever arm 178 of the moving apparatus 128 and moved to a target position. Here, the sample needle 126 can rotate freely about its own axis relative to its needle housing 192 or relative to the cantilever arm 178 of the moving apparatus 128. Apart from this rotation of its own, the sample needle 126 follows a movement of the moving apparatus 128.

FIG. 8 also shows a fitting 199 on which a capillary (not shown in FIG. 8) can be mounted as a sample receiving volume 132 in a high-pressure robust manner. The fitting 199 is attached to an upper side of the sample needle 126 and can receive the capillary such that the capillary can be guided outside the robot or cantilever arm 178. This enables easy maintenance or repair as well as unproblematic replacement of the sample receiving volume 132 by a user. Apart from the fitting 199, the capillary does not need to be attached to the cantilever arm 178.

It should be noted that the term “comprising” does not exclude other elements and that the term “a” does not exclude a plurality. Also, elements described in connection with different embodiments may be combined. It should also be noted that reference signs in the claims should not be construed as limiting the scope of protection of the claims.

1. A sample handling device for handling a fluidic sample in an analyzer for analyzing the fluidic sample, the sample handling device comprising:
a sample needle comprising a lumen for passing through the fluidic sample; and
a moving apparatus configured to move the sample needle by a rotational movement,
wherein the sample needle is rotatably mounted relative to the moving apparatus;
wherein the sample needle is rotatable about its own axis.

2. The sample handling device according to claim 1,
wherein the sample needle is connected and fluidically coupled to a sample receiving volume, and
wherein the rotatable mounting of the sample needle relative to the moving apparatus is configured such that a relative movement between the sample needle and the sample receiving volume is reduced.

3. The sample handling device according to claim 1, comprising a needle housing in which a part of the sample needle is mounted in such a way that when the sample needle rotates about its own axis, the needle housing remains stationary in a rotationally fixed manner.

4. The sample handling device according to claim 3, comprising one of the following features:
wherein the sample needle is mounted on the needle housing in such a way that the needle housing and the sample needle are rigidly coupled to one another in the direction of the sample needle's own axis;
wherein the sample needle is mounted on the needle housing in such a way that the needle housing and the sample needle can be moved relative to one another in the direction of the sample needle's own axis.

5. The sample handling device according to claim 3, wherein the sample needle has no further degree of freedom of movement relative to the needle housing in addition to its rotatability.

6. The sample handling device according to claim 1, comprising a rotation bearing for rotatably bearing the sample needle.

7. The sample handling device according to claim 6, comprising at least one of the following features:
wherein the rotation bearing is arranged between the sample needle and a needle housing in which a part of the sample needle is mounted;
wherein the rotation bearing is an outer bearing;
wherein the rotation bearing is an inner bearing;
wherein the rotation bearing is configured as a rolling bearing, in particular as a ball bearing;
wherein the rotation bearing is configured as a slide bearing;
wherein the rotation bearing is configured as a liquid bearing;
wherein the rotation bearing is configured as an air bearing;
wherein the rotation bearing is configured as a magnetic bearing;
wherein the rotation bearing comprises a first bearing stage and a second bearing stage spaced from the first bearing stage in the axial direction of the sample needle;
wherein the rotation bearing comprises a single bearing stage.

8. The sample handling device according to claim 2, wherein the sample receiving volume comprises a metallic capillary.

9. The sample handling device according to claim 2, wherein the sample receiving volume comprises a sample loop.

10. The sample handling device according to claim 9, comprising a fitting for fluidically coupling the sample needle to the sample receiving volume (132).

11. The sample handling device according to claim 1, wherein the sample needle has no further degree of freedom of movement relative to the moving apparatus in addition to its rotatability about its own axis.

12. The sample handling device according to claim 3, wherein the needle housing is rigidly attached to the moving apparatus.

13. The sample handling device according to claim 1, comprising any one of the following features:
wherein the sample handling device comprises an injector configured to inject the fluidic sample to be analyzed from an injector path of the sample handling device into a separation path of the analyzer;
wherein the sample handling device comprises a fractionator for fractionating the analyzed fluidic sample.

14. The sample handling device according to claim 1, comprising a fluid conveying device configured to draw the fluidic sample from a sample receiving device through the sample needle into a sample receiving volume of the sample handling device.

15. The sample handling device according to claim 1, wherein the moving apparatus comprises at least one selected from the group consisting of:
a cantilever arm configured to rotate the sample needle;
a linear moving apparatus configured to move the sample needle linearly along a linear direction;
a two-dimensional moving apparatus configured to move the sample needle in two spatial dimensions; and
a three-dimensional moving apparatus configured to move the sample needle in three spatial dimensions.

16. The sample handling device according to claim 1, comprising a needle seat into which the sample needle is insertable in a fluid-tight manner by moving the moving apparatus to guide fluidic sample through the sample needle and through the needle seat.

17. An analyzer for analyzing a fluidic sample, wherein the analyzer comprises at least one sample handling device according to claim 1 for handling the fluidic sample.

18. The analyzer according to claim 17, configured as a sample separation device,
wherein the sample handling device comprises an injector configured to inject the fluidic sample into the mobile phase; and
wherein the analyzer comprises a fluid drive configured to drive the mobile phase and the fluidic sample injected into the mobile phase and a sample separation device configured to separate the fluidic sample injected into the mobile phase.

19. The analyzer according to claim 17, further comprising at least one of the following features:
the analyzer is configured to analyze at least one physical, chemical and/or biological parameter of the fluidic sample;
the analyzer is configured as a sample separation device for separating the fluidic sample;
the analyzer is configured as a chromatography device;
the analyzer is configured as a microfluidic device;
the analyzer is configured as a nanofluidic device;
the sample separation device is configured as a chromatographic separation device;
the fluid drive is configured to drive the mobile phase and the fluidic sample with a pressure selected from the group consisting of: at least 500 bar; at least 1000 bar; and at least 1200 bar;
the analyzer comprises a detector for detecting the analyzed fluidic sample;
the analyzer comprises a fractionator for fractionating separate fractions of the fluidic sample.

20. A method of operating an analyzer for analyzing a fluidic sample, the method comprising:
passing fluidic sample through a lumen of a sample needle for transferring the fluidic sample between a sample receiving device and a sample receiving volume fluidically coupled to the sample needle;
rotationally moving the sample needle by a moving apparatus; and
rotating the sample needle relative to the moving apparatus,
wherein the sample needle is rotatably mounted relative to the moving apparatus;
wherein the sample needle is rotatable about its own axis.
